(19) United States
(12) Patent Application Publication
(10) Pub. No.: US 2009/0256093 A1
(43) Pub. Date: Oct. 15, 2009

(54) SOLENOID VALVE

(75) Inventors: Chieh-Cheng CHEN, Taoyuan Hsien (TW); Ming-Chih TSAI, Taoyuan Hsien (TW); Chien-Chia LIN, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/144,298

(22) Filed: Jun. 23, 2008

(30) Foreign Application Priority Data
Apr. 14, 2008 (TW) 97108997

(51) Int. Cl. F16K 31/02

(52) U.S. Cl. 251/129.15

(57) ABSTRACT

A solenoid valve comprises a bobbin, a coil, a valve rod, a slidable ring, and a rotatable ring. The bobbin has a through hole. The coil is wound around the bobbin. The valve rod is disposed in the through hole and is inwardly or outwardly movable along the through hole. The slidable ring is telescoped onto the valve rod and inwardly or outwardly movable with the valve rod. The rotatable ring is disposed inside the through hole and inside the slidable ring.

### CROSS REFERENCE TO RELATED APPLICATIONS

This application claims priority of Taiwan Patent Application No. 097108997, filed on Mar. 14, 2008, the entirety of which is incorporated by reference herein.

### BACKGROUND OF THE INVENTION

1. Field of the Invention

The present invention relates to a solenoid valve, and in particular relates to a self-latch solenoid valve with a structural design that replaces a permanent magnet.

2. Description of the Related Art

A conventional self-latch solenoid valve is switched between an extended position and a retracted position by passing an electric current through a coil, wherein the position of the valve rod is fixed, even after the electric current is terminated. To save power, a conventional self-latch solenoid valve generally contains a magnet to attract and keep the valve rod in a retracted position when the electric current is terminated, thus, keeping the self-latch solenoid valve open.

FIG. 1A is a stereogram of a conventional self-latch solenoid valve. FIG. 1B is a stereogram of FIG. 1A with a part of structure removed. A solenoid valve 5 includes at least one permanent magnet 51, a valve rode 52, a coil 53, and a spring 54.

In FIG. 1A and FIG. 1B, the valve rode 52 of the solenoid valve 5 is located in a retracted position. When power is supplied to the solenoid valve 5, the coil 53 are provided with voltage current to attract the valve rode 52, and then the valve rod 5 is moved from an extended position A to a retracted position B. When the valve rod 52 is moved to the retracted position B, the permanent magnet 51 attracts the valve rod 52. Then, the power can be terminated with the solenoid valve 5 kept open.

If the coil 53 is provided with a reverse current (opposing the excitation current direction), then a reverse magnetic field is generated to cancel the attraction of the magnet on the valve rod, and the valve rod 52 is pushed to the extended position A by the spring 54. Then, the power can be terminated with the solenoid valve 5 kept closed.

For the solenoid valve 5, however, a driving circuit is necessary to be equipped with a bridge circuit to control the solenoid valve 5, reduce energy dissipation, and save power. Moreover, the solenoid valve 5 is equipped with a fixing structure 55 for fixing the permanent magnet 51, thus, requiring high manufacturing costs.

FIG. 2A is a stereogram of another conventional self-latch solenoid valve, and FIG. 2B is a stereogram of FIG. 2A with a part of structure removed. The solenoid valve 6 includes at least one permanent magnet 61, a valve rode 62, a first coil 631, a second coil 632, a spring 64, and a fixing structure 65 for fixing the permanent magnet 61.

In FIG. 2A and FIG. 2B, the valve rode 62 of the solenoid valve 6 is located in an extended position. The first coils 631 is provided with an excitation voltage to attract the valve rode 62 when power is supplied to the solenoid valve 6, and then the valve rod 62 is moved from an extended position A to a retracted position B. The permanent magnet 61 attracts the valve rod 62 when the valve rod 62 is moved to the retracted position B. Then, the power is terminated and the solenoid valve 6 is kept open (not shown).

Furthermore, the second coil 632 is provided with an excitation voltage to attract the valve rode 62 in an opposite direction when power is supplied to the solenoid valve 6 again, and then the valve rod 62 is moved from the retracted position B to the extended position A. The valve rod 62 is released from the permanent magnet 61 when the valve rod 62 is moved to the extended position A. Then, the power is terminated and the solenoid valve 6 is kept closed (not shown).

The solenoid valve 6 is necessary to be equipped with a digital switch circuit to control the first coil 631 and the second coil 632 for reducing energy dissipation and saving power. Moreover, the solenoid valves 6 are usually equipped with a fixing structure 65 for fixing the permanent magnet 61, the first coil 631, and the second coil 632. Similarly, the above-mentioned design requires more components, and therefore increases manufacturing costs and complicates the manufacturing process.

### BRIEF SUMMARY OF THE INVENTION

A detailed description is given in the following embodiments with reference to the accompanying drawings.

To solve the problems of the conventional solenoid valve, it is an object of the present invention to provide a solenoid valve with a structural design that replaces a permanent magnet and a fixing structure for maintaining the self-latch solenoid valve in a normal open or a normal closed position. Advantages of the present invention include economized energy usage, reduced element materials, simplified manufacturing processes, reduced manufacturing costs, and simplified circuit design.

To achieve the above, the present invention provides a solenoid valve including a bobbin, a coil, a valve rod, a slidable ring, and a rotatable ring. The bobbin has a through hole. The coil is wound around the bobbin. The valve rod is disposed in the through hole and is inwardly or outwardly movable along the through hole. The slidable ring is telescoped onto the valve rod and is inwardly or outwardly movable with the valve rod simultaneously. There is an inward thrust applied on the slidable ring. The rotatable ring is disposed inside the through hole and inside the slidable ring and sustains the slidable ring by the outward thrust. The valve rod is maintained in an extended position by the outward thrust and in a retracted position by the inward thrust. A bottom of inner wall of the through hole has an inclined surface, the rotatable ring engages with the inclined surface and the slidable ring and the valve rod do not sustain the outward thrust when the valve rod is located in the retracted position. The outward thrust is greater than the inward thrust when the valve rod is located in the extended position. The coil of the valve rod is provided with an excitation voltage to switch the valve rod between the extended position and the retracted position.

For the above descriptions, the structural design of the solenoid valve of the invention including the slidable ring, the rotatable ring, the bobbin, and the guiding grooves is used to achieve the functions of a normal open and a normal closed position of the solenoid valve without the application of the permanent magnet and the fixing structure. Thus, advantages of the present invention include economized energy usage, reduced element materials, simplified manufacturing processes, and reduced manufacturing costs. Moreover, the excitation voltage is a pulse voltage to simplify the driving circuit design.

### BRIEF DESCRIPTION OF THE DRAWINGS

The present invention can be more fully understood by reading the subsequent detailed description and examples with references made to the accompanying drawings, wherein:

FIGS. 1A and 1B are stereograms of a conventional self-latch solenoid valve.

FIGS. 2A and 2B are stereograms of another conventional self-latch solenoid valve.

FIG. 3A is a stereogram of a solenoid valve with a part thereof removed in accordance with an embodiment of the present invention.

FIG. 3B is an exploded view of the solenoid valve of FIG. 3A.

FIG. 4 is a stereogram of a bobbin with a part thereof removed, a slidable ring and a rotatable ring in accordance with the embodiment of the present invention.

FIG. 5 is an outspread diagram of a bobbin incised along a guiding groove in accordance with an embodiment of the present invention.

FIG. 6A is a cross sectional view of a bobbin.

FIG. 6B is a cross sectional view of a bobbin with a slidable ring accommodated therein.

FIG. 6C is a cross sectional view of a bobbin with a rotatable ring accommodated in a bottom thereof.

FIGS. 7A-7E depict the processes of a valve rod moving from an extended position to a retracted position in accordance with the embodiment of the invention.

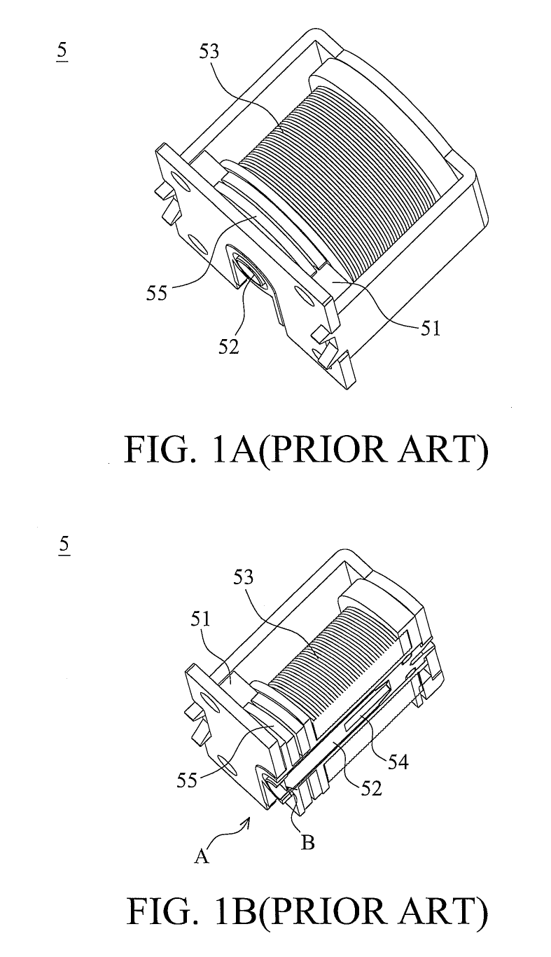

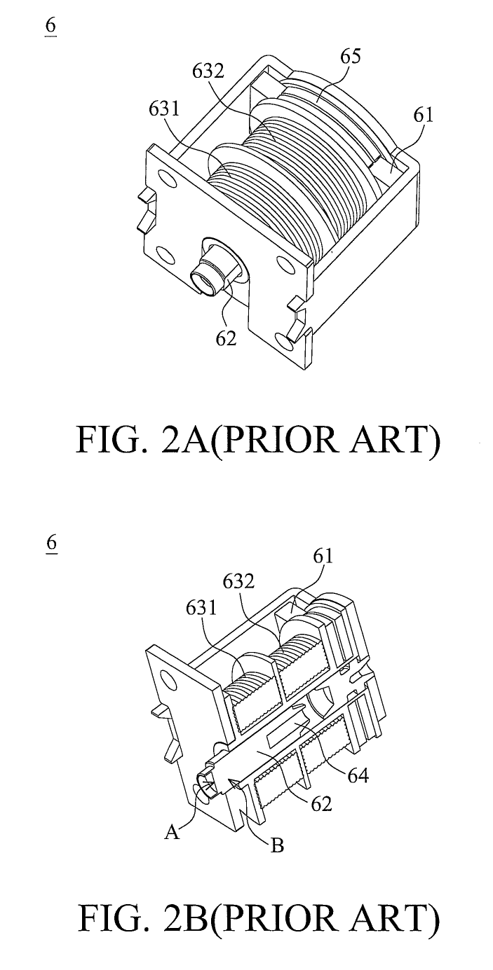

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

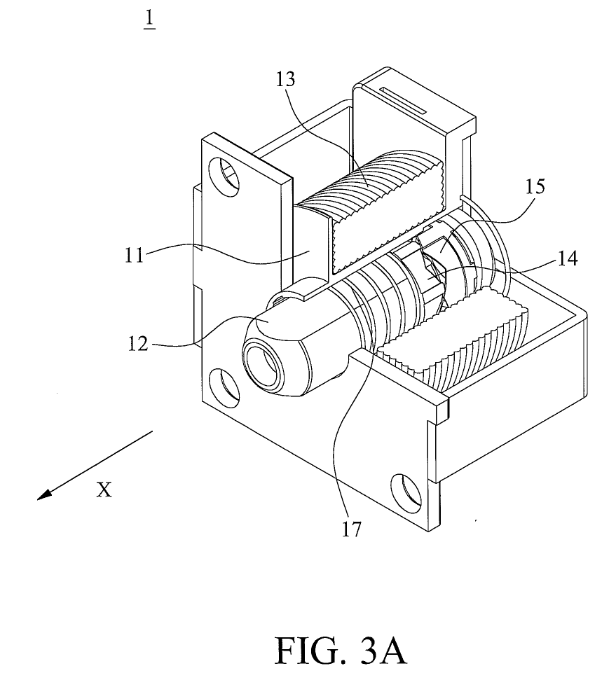

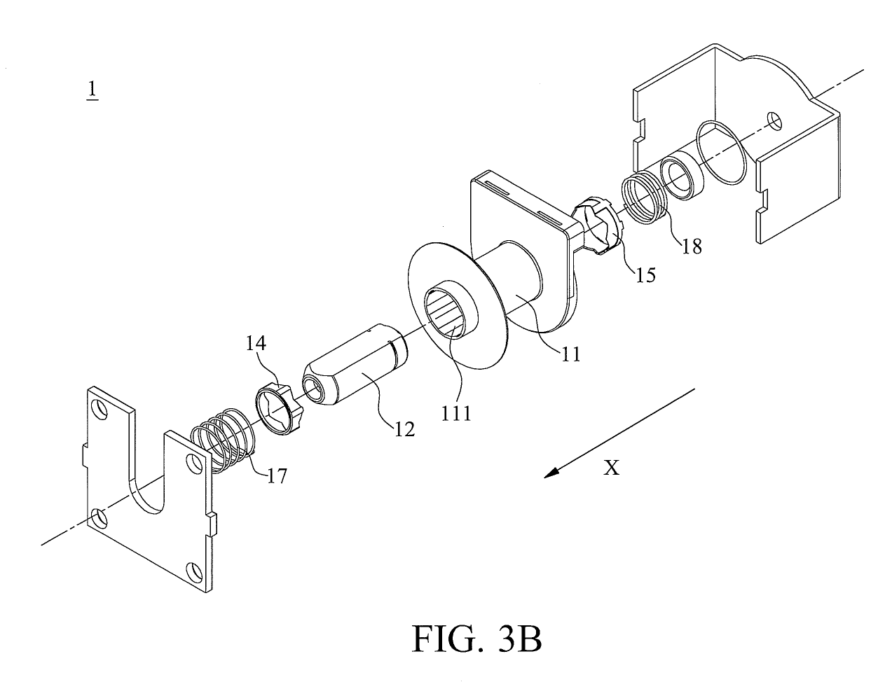

FIG. 3A is a stereogram of a solenoid valve with a part thereof removed in accordance with an embodiment of the present invention, and FIG. 3B is an exploded view of the solenoid valve of FIG. 3A. The solenoid valve 1 includes a bobbin 11, a valve rod 12, a coil 13, a slidable ring 14, a rotatable ring 15, a first spring 17, and a second spring 18.

The coil 13 is wound around the bobbin 11. The bobbin 11 has a through hole 111. The valve rod 12 is a movable iron core and disposed in the through hole 111 and is inwardly or outwardly movable in an axial direction X of the through hole 111 of the bobbin 11.

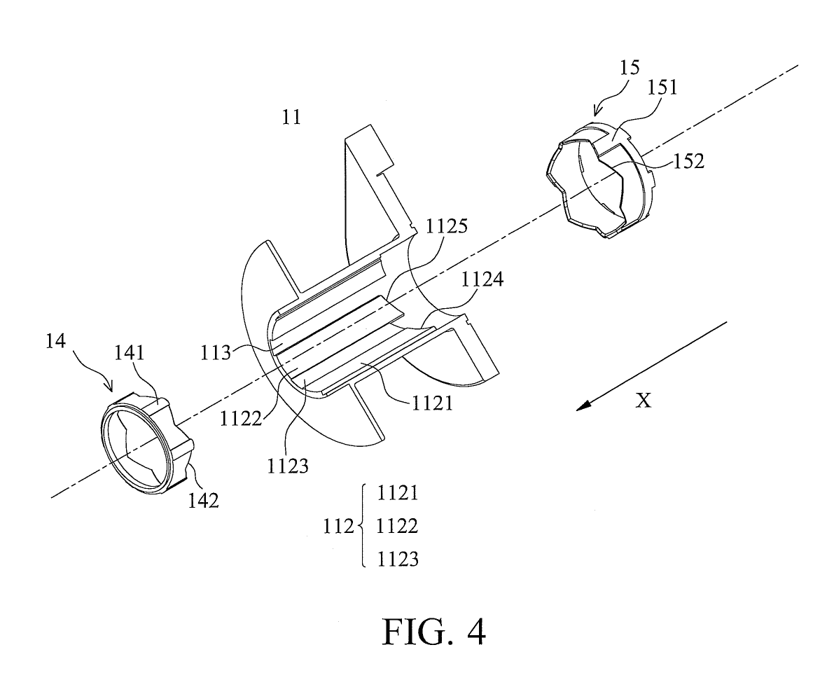

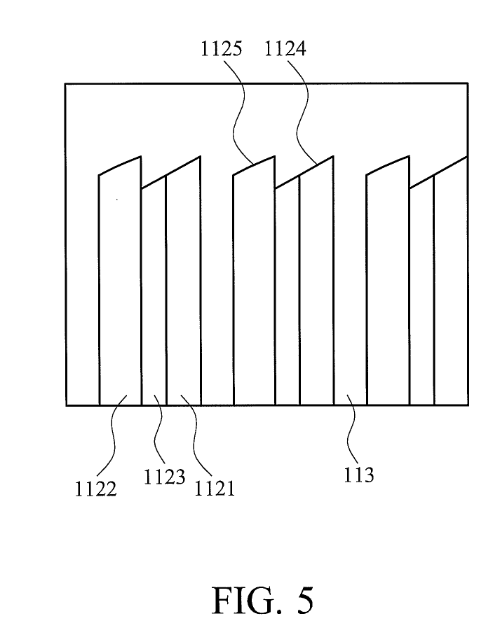

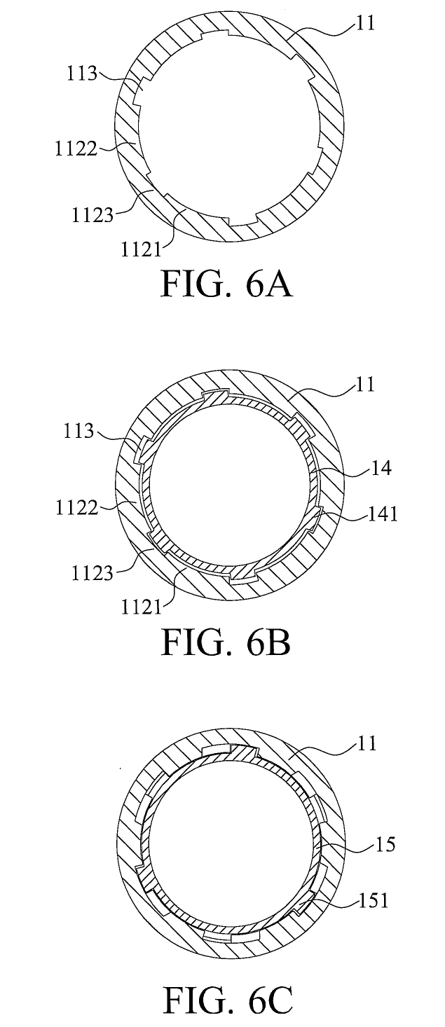

FIG. 4 is a stereogram of a bobbin with a part thereof removed, a slidable ring, and a rotatable ring in accordance with an embodiment of the present invention. FIG. 5 is an outspread diagram of a bobbin incised along a guiding groove in accordance with an embodiment of the present invention. FIG. 6A is a cross sectional view of a bobbin. FIG. 6B is a cross sectional view of a bobbin with a slidable ring accommodated therein. FIG. 6C is a cross sectional view of a bobbin with a rotatable ring accommodated in a bottom thereof. A plurality of rib parts 112 and a plurality of guiding grooves 113 are alternately arranged on an inner wall of the bobbin 11. Each of the rib parts 112 has a first rib 1121, a second rib 1122, and a middle rib 1123 with a minor recess disposed between the first rib 1121 and the second rib 1122. The bottom of the first rib 1121 and the middle rib 1123 commonly have a first inclined surface 1124, and the second rib 1122 has a second inclined surface 1125.

Referring to FIG. 4 and FIG. 6B, the slidable ring 14 telescoped onto the valve rod 12 and is inwardly or outwardly movable along an axial direction X with the valve rod 12, wherein the slidable ring 14 sustains an inward thrust. The inward thrust arises from a spring, gravity, or friction from tight fit. The slidable ring 14 has a plurality of first projections 141 correspondingly accommodated in the middle ribs 1123 and guiding grooves 113 of the bobbin 11 and slidable in the axial direction X. A first teeth part 142 is disposed at a bottom of the slidable ring 14. The slidable ring 14 has a plurality of first toothed tips, and each of the first projections 141 corresponds to each of the first toothed tips.

Referring to FIG. 4 and FIG. 6C, the rotatable ring 15 is disposed inside the through hole 111 and inside the slidable ring 14, and the rotatable ring 15 sustains an outward thrust. The outward thrust arises from a spring (not limited thereto). The rotatable ring 15 has a second teeth part 152 for engaging with the first teeth part 142. The second teeth part 152 has a plurality of second toothed tips. The second projections 151 of the rotatable ring 15 are correspondingly accommodated in the guiding grooves 113, and the first teeth part 142 does not engage with the second teeth part 152 when the first projections 141 and the second projections 151 are accommodated in the guiding grooves 113.

A first spring 17 is disposed in the through hole 111, outside the slidable ring 14, and around the valve rod 12, wherein an end of the first spring 17 is fixed to the bobbin 11, and the first spring 17 provides the inward thrust on the slidable ring 14 and the valve rod 12.

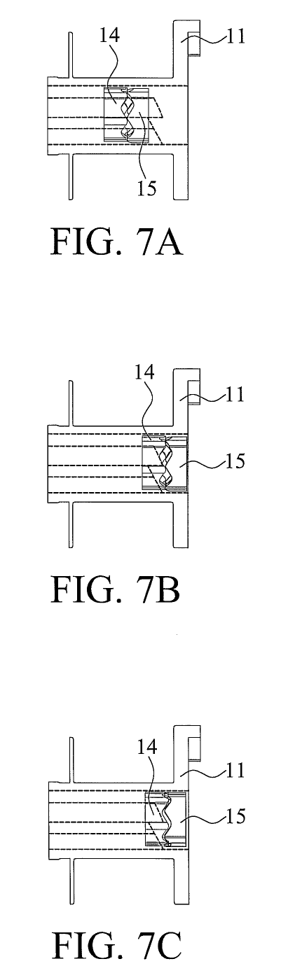

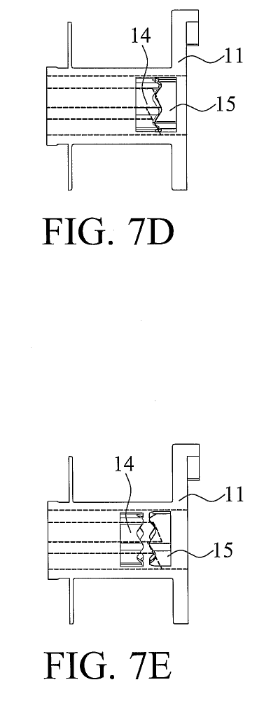

FIGS. 7A-7E depict the processes of a valve rod moving from an extended position to a retracted position in accordance with the embodiment of the invention. The coil 13 is provided with an excitation voltage to retract the valve rod 12 by attraction from the extended position to the retracted position when power is supplied to the coil 13 of the solenoid valve 1, as will be described in detail in the following.

The first projections 141 of the slidable ring 14 and the second projections 151 of the rotatable ring 15 are accommodated in the guiding grooves 113 when the valve rod 12 is in the extended position, and then the valve rod 12 is maintained in the extended position by the outward thrust. Thus, the outward thrust is greater than the inward thrust.

Referring to FIG. 7A, when the power is supplied to the coil 13 of the solenoid valve 1, the valve rod 12 retracts to force the slidable ring 14 to slide inwardly simultaneously, and pushes the rotatable ring 15 inward along the guiding grooves 113 of the bobbin 11.

Referring to 7B, the rotatable ring 15 leaves the guiding grooves 13 of the bobbin 11.

Referring to FIG. 7C, after the second projections 151 of the rotatable ring 15 leave the guiding grooves 113, the rotatable ring 15 engages with the slidable ring 14 to rotate an angle (around 30 degrees, but not limited thereto).

At this moment, the power is terminated, and then the valve rod 12 and the slidable ring 14 begin to move outwardly.

Referring to FIG. 7D, the second projections 151 of the rotatable ring 15 slide along the first inclined surfaces 1124 to rotate another angle, and then are stuck between the first inclined surfaces 1124 and the second ribs 1122. Then, the slidable ring 14 and the valve rod 23 are maintained in the retracted position by the inward thrust arising from the first spring 17.

Furthermore, the movement of the valve rod 12 from the retracted position to the extended position is described in detail in the following.

When the valve rod 12 is retracted inwardly due to the excitation voltage, the rotatable ring 15 engages with the slidable ring 14 to rotate an angle. When the valve rod 12 moves outwardly, the second projections 151 slide along the second inclined surfaces 1125 to rotate another angle, and then slide into the guiding grooves 113. Then, the rotatable ring 15, the slidable ring 14 and the valve rod 12 are maintained in the extended position by the outward thrust arising from the second spring 18.

In sum, in the embodiment, there are three guiding grooves 113 (not limited thereto) in the bobbin 11. The rotatable ring 15 is stuck between the first inclined surface 1124 and the second rib 1122 after rotating an angle (around 60 degrees, but not limited thereto). Thus, the valve rod is maintained in the retracted position without outward thrust arising from the second spring to keep the solenoid valve 6 open.

The rotatable ring 15 further rotates 60 degrees to be accommodated in the next guiding groove 113 of the bobbin 11 when power is supplied to the solenoid valve 6 again. Thus, the valve rod 12 is moved to the extended position by the outward thrust arising from the second spring 18 to keep the solenoid valve 6 closed.

In this embodiment, the excitation voltage is a pulse voltage or a transient digital signal, and the coil 13 is provided with an excitation voltage to switch the valve rod 12 between the extended position and the retracted position.

Structurally, the solenoid valve of the invention includes the slidable ring, the rotatable ring, the bobbin, and the guiding grooves, all of which are used to keep the solenoid valve open or closed without a permanent magnet and a fixing structure. Thus, advantages of the present invention include economized energy usage, reduced components, simplified manufacturing processes, and reduced manufacturing costs. Moreover, the excitation voltage is a pulse voltage capable of simplifying driving circuit design.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A solenoid valve comprising:
a bobbin having a through hole;
a coil wound around the bobbin;
a valve rod disposed in the through hole and capable of moving inwardly or outwardly along the through hole;
a slidable ring telescoped onto the valve rod and inwardly or outwardly movable with the valve rod; and
a rotatable ring disposed inside the through hole and the slidable ring.

2. The solenoid valve as claimed in claim 1, wherein the valve rod is a movable iron core.

3. The solenoid valve as claimed in claim 1, wherein the valve rod is maintained in an extended position by an outward thrust of the rotatable ring and in a retracted position by an inward thrust of the slidable ring.

4. The solenoid valve as claimed in claim 3, wherein a bottom of a inner wall of the through hole has an inclined surface, and when the valve rod is located in the retracted position, the rotatable ring engages with the inclined surface and the slidable ring and the valve rod do not sustain the outward thrust,
wherein the outward thrust is greater than the inward thrust when the valve rod is located in the extended position.

5. The solenoid valve as claimed in claim 3, wherein the outward thrust arises from a spring, and the inward thrust arises from a spring, gravity, or friction.

6. The solenoid valve as claimed in claim 3, wherein the coil is provided with voltage voltage to switch the valve rod between the extended position and the retracted position.

7. The solenoid valve as claimed in claim 6, wherein the excitation voltage is a pulse voltage or a transient digital signal.

8. The solenoid valve as claimed in claim 3, further comprising a first spring disposed in the through hole, outside the slidable ring, and around the valve rod, wherein an end of the first spring is fixed to the bobbin, and the first spring provides the inward thrust on the slidable ring.

9. The solenoid valve as claimed in claim 3, further comprising a second spring disposed in the through hole and inside the rotatable ring and providing the outward thrust on the rotatable ring.

10. The solenoid valve as claimed in claim 3, wherein an inner wall of the through hole of the bobbin have a plurality of rib parts and a plurality of guiding grooves, and the rib parts and the guiding grooves are alternately arranged.

11. The solenoid valve as claimed in claim 10, wherein each of the rib parts has a first rib, a second rib, and a middle rib disposed between the first rib and the second rib, and a bottom of the first rib and the middle rib have a first inclined surface, and the second rib has a second inclined surface.

12. The solenoid valve as claimed in claim 11, wherein the slidable ring has a plurality of the first projections corresponding to the guiding grooves and the middle ribs of the bobbin, respectively, and is outwardly and inwardly slidable along an axial direction of the through hole;
wherein the slidable ring further has a first teeth part disposed at a bottom of the first projections and provided with a plurality of first toothed tips, and each of the first projections corresponds to each of the first toothed tips.

13. The solenoid valve as claimed in claim 12, wherein the rotatable ring has a second teeth part and a plurality of second projections, the second teeth part has a plurality of second toothed tips engaged with the first teeth part, and the second projections are correspondingly accommodated in the guiding grooves;
wherein the first teeth part does not engage with the second teeth part when the first projections and the second projections are accommodated in the guiding grooves.

14. The solenoid valve as claimed in claim 12, wherein when the coil is provided with voltage voltage to extract the valve rod, the rotatable ring engages with the slidable ring to rotate an angle.

15. The solenoid valve as claimed in claim 13, wherein the voltage is a pulse voltage or a transient digital signal.

16. The solenoid valve as claimed in claim 14, wherein the first projections and the second projections are accommodated in the guiding grooves when the valve rod is located in the extended position.

17. The solenoid valve as claimed in claim 16, wherein when the valve rod is retracted inwardly due to the excitation voltage, the second projections of the rotatable ring leave the guiding grooves, and then the rotatable ring engages with the slidable ring to rotate an angle.

18. The solenoid valve as claimed in claim 17, wherein when the valve rod moves outwardly, the second projections of the rotatable ring slide along the first inclined surface to rotate another angle, and the second projections are stuck between the first inclined surfaces and the second ribs, and the slidable ring and the valve rod are maintained in the retracted position by the inward thrust.

19. The solenoid valve as claimed in claim 14, wherein when the valve rod is located in the retracted position, the second projections of the rotatable ring are stuck between the first inclined surfaces and the second ribs of the through hole.

20. The solenoid valve as claimed in claim 19, wherein when the valve rod is retracted inwardly due to the voltage, the rotatable ring engages with the slidable ring to rotate an angle, and then when the valve rod moves outwardly, the second projections of the rotatable ring slide along the second inclined surface to rotate another angle, and the second projections slide into the guiding grooves, and then the rotatable ring, the slidable ring, and the valve rod are maintained in the extended position by the outward thrust.
